(19) United States
(12) Patent Application Publication
(10) Pub. No.: US 2019/0025825 A1
(43) Pub. Date: Jan. 24, 2019

(54) Autonomous Driving Control Apparatus and Autonomous Driving Control Method

(71) Applicant: Hitachi Automotive Systems, Ltd., Hitachinaka-shi, Ibaraki (JP)

(72) Inventor: Taku TAKAHAMA, Yokohama-shi, Kanagawa (JP)

(21) Appl. No.: 16/072,381

(22) PCT Filed: Dec. 19, 2016
(86) PCT No.: PCT/JP2016/087737

§ 371 Date: Jul. 24, 2018

(30) Foreign Application Priority Data
Jan. 25, 2016 (JP) 2016-011783

(51) Int. Cl. G05D 1/00; B60W 30/182; B60W 50/14

(52) U.S. Cl. CPC G05D 1/0061; G05D 1/0088; B60W 2050/143; B60W 50/14; G05D 2201/0213; B60W 30/182

(57) ABSTRACT

Provided is an autonomous driving control apparatus and an autonomous driving control method capable of prompting a driver to switch a driving mode to a manual driving mode when a vehicle enters an area in which autonomous driving is difficult. The autonomous driving control apparatus includes a subject vehicle position detection portion configured to detect a running point of a subject vehicle on a map, a driving mode switching portion configured to, when the driver performs a driving operation during an autonomous driving mode of performing at least a part of a driving operation of the driver on behalf of the driver, switch the driving mode from the autonomous driving mode to the manual driving mode of causing the subject vehicle to run according to the driving operation, an autonomous driving difficulty determination portion configured to, based on information regarding an area lying ahead of the running point of the subject vehicle in a traveling direction, determine whether the autonomous driving is difficult in the area, and a driving mode switching prompt portion configured to prompt the driver to switch the driving mode to the manual driving mode if the autonomous driving is determined to be difficult in the area.

### TECHNICAL FIELD

The present invention relates to an autonomous driving control apparatus and an autonomous driving control method.

### BACKGROUND ART

Conventional autonomous driving control apparatuses switch a driving mode to a manual driving mode when a driver performs a driving operation during autonomous driving. PTL 1 discusses one example regarding the above-described technique.

### CITATION LIST

### Patent Literature

[PTL 1] Japanese Patent Application Public Disclosure No. 2000-276690

### SUMMARY OF INVENTION

### Technical Problem

When the vehicle enters an area in which the autonomous driving is difficult, the driver should switch the driving mode from the autonomous driving mode to the manual driving mode. Therefore, there are needs desiring the autonomous driving control apparatuses to prompt the driver to switch the driving mode to the manual driving mode when the vehicle enters the area in which the autonomous driving is difficult.

An object of the present invention is to provide an autonomous driving control apparatus and an autonomous driving control method capable of prompting the driver to switch the driving mode to the manual driving mode when the vehicle enters the area in which the autonomous driving is difficult.

### Solution to Problem

According to one embodiment of the present invention, an autonomous driving control apparatus prompts a driver to switch a driving mode to a manual driving mode if, based on information regarding an area lying ahead of a running point of a subject vehicle in a traveling direction, autonomous driving is determined to be difficult in this area.

Therefore, the autonomous driving control apparatus can prompt the driver to switch the driving mode to the manual driving mode when the vehicle enters the area in which the autonomous driving is difficult.

### BRIEF DESCRIPTION OF DRAWINGS

FIG. 1 illustrates a configuration of an autonomous driving control apparatus according to a first embodiment.

FIG. 2 illustrates a configuration of a navigation system 2 according to the first embodiment.

FIG. 3 illustrates one example of a map screen 22 displayed on a display device 15 by the navigation system 2.

FIG. 4 illustrates one example of a turn-by-turn screen 24 displayed on the display device 15 by the navigation system 2.

FIG. 5 is a flowchart illustrating a flow of a task regarding autonomous driving according to the first embodiment.

FIG. 6 is a flowchart illustrating a flow of a task regarding switching of a running mode according to the first embodiment.

FIG. 7 is a flowchart illustrating the flow of the task regarding the switching of the running mode according to the first embodiment and a second embodiment.

FIG. 8 illustrates an operation of the task regarding the switching of the running mode according to the first embodiment when a vehicle enters an area in which the autonomous driving is difficult during the autonomous driving.

FIG. 9 is a flowchart illustrating the flow of the task regarding the switching of the running mode according to the second embodiment and a third embodiment.

FIG. 10 is a flowchart illustrating the flow of the task regarding the switching of the running mode according to the second embodiment and the third embodiment.

FIG. 11 is a flowchart illustrating the flow of the task regarding the switching of the running mode according to the third embodiment.

### DESCRIPTION OF EMBODIMENTS

### First Embodiment

[Autonomous driving Control Apparatus]

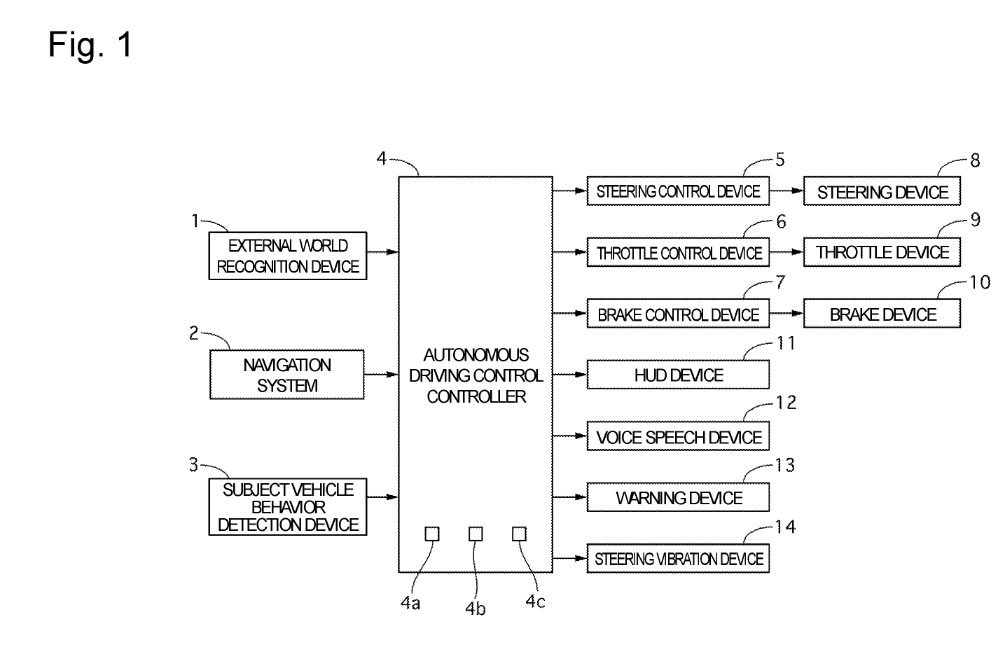

FIG. 1 illustrates a configuration of an autonomous driving control apparatus according to a first embodiment.

The autonomous driving control apparatus according to the first embodiment is mounted on a vehicle that uses an engine as a power source thereof. An external world recognition device 1 recognizes an environment (a shape of a road, a white line, an obstacle, and the like) surrounding a subject vehicle from a camera, a laser radar, and/or the like mounted on the subject vehicle. A navigation system 2 sets a recommended route from a current position of the subject vehicle to a destination set by a driver, and presents a route guide to the driver. Details thereof will be described below. A subject vehicle behavior detection device 3 detects a behavior of the subject vehicle from each of signals of a steering angle sensor that detects a steering angle of a front wheel, a vehicle speed sensor that detects a vehicle speed, a lateral G sensor that detects a lateral G, a yaw rate sensor that detects a yaw rate, a turn signal, and the like. An autonomous driving control controller 4 switches a running mode to an autonomous driving mode upon satisfaction with predetermined autonomous driving start conditions including the driver's selection of autonomous driving (for example, turning on an autonomous driving selection button). The autonomous driving control controller 4 controls steering and the vehicle speed so as to cause the subject vehicle to automatically run based on the recommended route independently of a driving operation (a steering wheel operation and a pedal operation) performed by the driver during the autonomous driving mode. More specifically, during the autonomous driving mode, the autonomous driving control controller 4 calculates a target steering angle of the front wheel in the steering control and also calculates a target steering angle of the subject vehicle in the vehicle speed control, based on the environment surrounding the subject vehicle and the behavior of the subject vehicle. A steering control device 5 drives a steering device 8 that steers the front wheel in such a manner that the steering angle of the front wheel matches the target steering angle. A throttle control device 6 drives a throttle device 9 that opens and closes a throttle valve in such a manner that the vehicle speed of the subject vehicle matches the target vehicle speed. A brake control device 7 drives a brake device 10 that provides a braking force to each wheel in such a manner that the vehicle speed of the subject vehicle matches the target vehicle speed. An HUD device 11 displays vehicle information such as the vehicle speed, the route guide of the navigation system 2, and the like on a windshield of the subject vehicle as a virtual image. A voice speech device 12 speaks various kinds of warnings, the route guide of the navigation system 2, and the like as a synthesized voice. A warning device 13 issues the various kinds of warnings by outputting a warning sound. A steering vibration device 14 issues various kinds of warnings by vibrating a steering wheel.

When the driver's diving operation (the steering wheel operation or the pedal operation, hereinafter also referred to as override) is detected during the autonomous driving mode, the autonomous driving control controller 4 switches the running mode from the autonomous driving mode to a manual driving mode. Hereinafter, the switching from the autonomous driving mode to the manual driving mode will also be referred to as “switching from the autonomous mode to the manual mode”, and the switching from the manual driving mode to the autonomous driving mode will also be referred to as “switching from the manual mode to the autonomous mode”. In the manual driving mode, the vehicle is controlled according to the driver's driving operation similarly to normal running in which the driver does not select the autonomous driving. Further, the autonomous driving control controller 4 switches the running mode from the manual mode to the autonomous mode when the autonomous driving start conditions are satisfied during the manual driving mode.

[Navigation System]

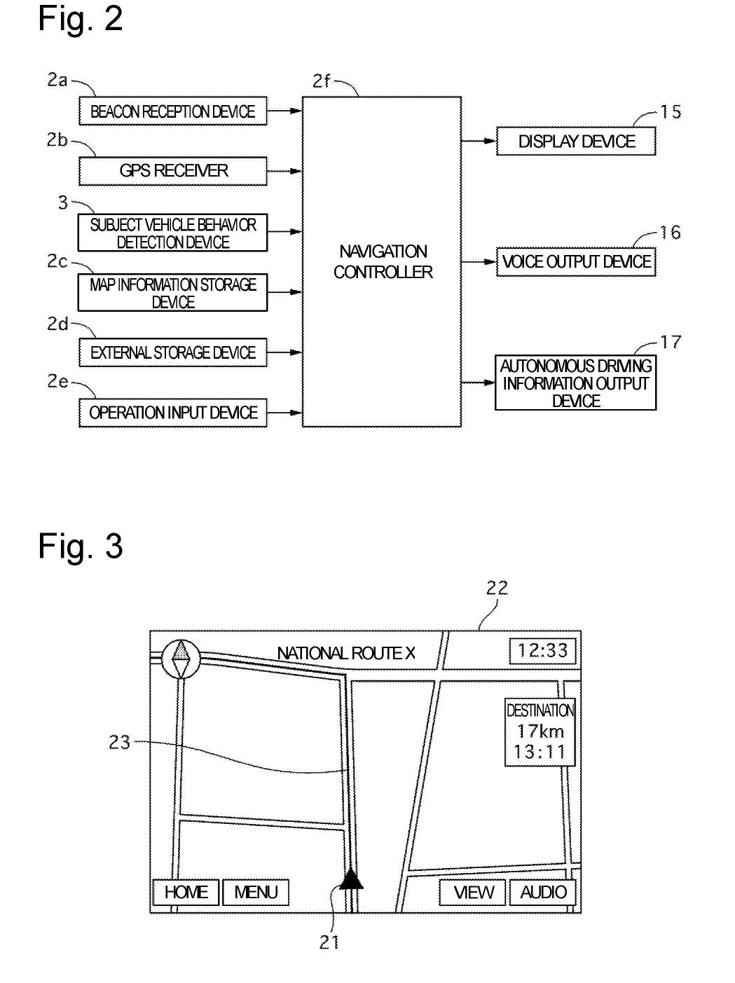

FIG. 2 illustrates a configuration of the navigation system 2 according to the first embodiment.

A beacon reception device 2a acquires traffic information from a radio wave, an optical beacon, or the like.

A GPS receiver 2b receives longitude and latitude of the subject vehicle from a plurality of satellites (GPS satellites). A map information storage device 2c stores therein information of a road map (information of a node and a link to which a road attribute is attached). Information held by the node is a name of an intersection (Kanji characters and pronunciation thereof), whether there is a traffic light, and the like. Information held by the link is a type of the link (for example, a “through traffic link” indicating a through traffic portion of a road, a “connection road link” for connecting through traffic lanes such as an entrance/exit and a junction of an expressway or the like, or an “intersection inside link” clearly indicating that this link is inside an intersection of an ordinary road), a road type, a road management authority (for example, a national government, a prefectural government, or a municipal government), a road width, the number of traffic lanes, a road name, a road number (for example, a route number of a national highway), a traffic regulation (for example, one-way traffic, traffic prohibition or the like), VICS (Vehicle Information and Communication System: registered trademark) information, a speed limit (a maximum speed), and the like. An external storage device 2d stores therein information regarding a state of the subject vehicle. An operation input device 2e is, for example, a touch panel and/or a switch, and is operated when the driver, for example, inputs the destination or changes a display.

A navigation controller (a subject vehicle position detection portion) 2f performs various kinds of processing for presenting the route guide to the driver. For example, as illustrated in FIG. 3, the navigation controller 2f detects a current position of the subject vehicle from the information of the longitude and latitude of the subject vehicle and the road map, develops a road map around the subject vehicle into graphics, and displays a map screen 22, on which a mark 21 indicating the current position is superimposed, on the display device 15 as a normal screen of a navigation screen. When the GPS receiver 2b cannot receive the longitude and latitude of the subject vehicle, the navigation controller 2f estimates the current position from dead reckoning based on the behavior of the subject vehicle that is input from the subject vehicle behavior detection device 3. The display device 15 is, for example, a liquid crystal display or an organic EL display. Further, the navigation controller searches for an optimum recommended route 23 connecting the current position and the destination in consideration of the traffic information and the like and displays the recommended route on the map screen 22 in a superimposed manner, and also guides the driver with use of the display by the display device 15 and/or a speech by a voice output device 16. The voice speech device 12 may be used as the voice output device 16.

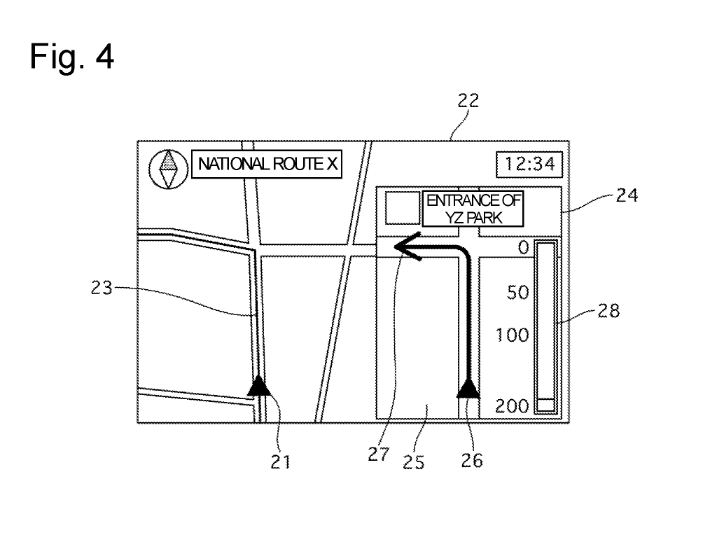

Further, when a distance to a branch at which the subject vehicle should change a driving direction thereof (an intersection or the like) falls to or below a predetermined threshold value for a turn-by-turn display, the navigation controller 2f displays a turn-by-turn screen 24 on the navigation screen as illustrated in FIG. 4 and also prompts the driver to change the driving direction with use of the speech of the voice output device 16 until the branch appears. The turn-by-turn is one type of user interface of the navigation system 2, and refers to a display method of displaying a traveling direction at an intersection or the like with use of a voice, an arrow icon, and the like. On the turn-by-turn screen 24, a mark 26 indicating the current positon, an arrow 27 indicating the driving direction, and a scale 28 indicating the distance to the branch are displayed on a map screen 25 displaying a map from the current position to the branch. The turn-by-turn screen 24 may be displayed on the windshield with use of the HUD device 11.

An autonomous driving information output device 17 outputs, as the navigation information, the information held by each node and each link on the recommended route and timings of a start and an end of the display of the turn-by-turn screen 24 to a not-illustrated CAN communication line.

[Regarding Partial Autonomous driving]

The autonomous driving according to the first embodiment is partial autonomous driving only in charge of uncomplicated running along a road in the recommended route. In the autonomous driving, the autonomous driving control apparatus keeps the subject vehicle at approximately a center of a lane (a running lane) while maintaining a distance to a vehicle running ahead as appropriate, and, for example, avoids (moves through or overtakes) an obstacle when necessary. The autonomous driving control apparatus limits the autonomous driving to the uncomplicated running along a road, and leaves the driving to the driver's operation when the vehicle changes the driving direction at an intersection or the like or in an area where the autonomous driving is difficult due to a configuration of the sensor and the like, and therefore can realize a cost reduction due to a reduction in the number of sensors and simplification of the control and achieve improvement of safety compared to when employing the autonomous driving all through the recommended route. Generally, most (approximately 90 percent) of a total driving time is the uncomplicated running along a road, and a time during which the vehicle changes the driving direction or runs in the area where the autonomous driving is difficult is only a short period of time (approximately 10 percent). Therefore, even when limiting the autonomous driving only to the running along a road, the autonomous driving control apparatus can cover most of the total driving time, and does not significantly impair convenience of the autonomous driving.

In the above-described partial autonomous driving, the switching from the autonomous mode to the manual mode is carried out at a timing when the override by the driver is detected. This brings about an effect of allowing the driver to switch the running mode from the autonomous mode to the manual mode at an arbitrary timing, thereby avoiding an end of the autonomous driving at a timing unexpected by the driver. On the other hand, the driver should switch the running mode from the autonomous mode to the manual mode every time the vehicle changes the driving direction or enters the area in which the autonomous driving is difficult. Then, when the vehicle changes the driving direction, even if the driver does not override the autonomous driving, the running along a road continues, so that a departure from the lane can be prevented or reduced and thus the vehicle is prevented from obstructing a traffic flow. However, when the vehicle enters the area in which the autonomous driving is difficult, the driver necessarily has to switch the running mode from the autonomous mode to the manual mode. Therefore, in the first embodiment, the autonomous driving control apparatus carries out a task regarding the autonomous driving like an example that will be described below, aiming at prompting the driver to switch the running mode to the manual driving mode, when the vehicle enters the area in which the autonomous driving is difficult.

[Task regarding Autonomous driving]

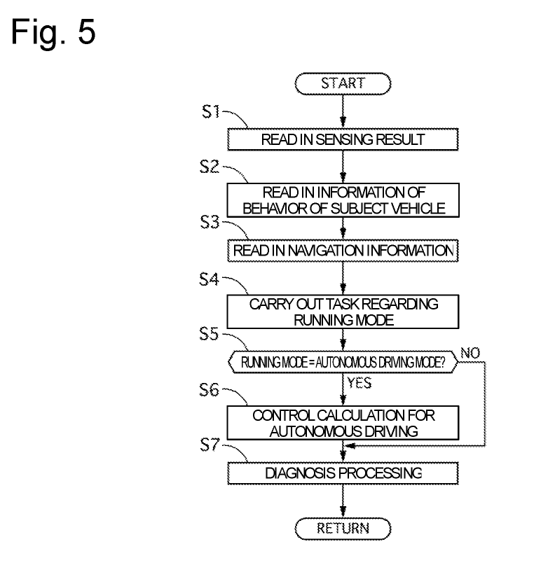

FIG. 5 is a flowchart illustrating a flow of the task regarding the autonomous driving according to the first embodiment. This processing is repeated per predetermined control cycle (for example, 10 ms) by the autonomous driving control controller 4.

In step S1, the autonomous driving control controller 4 reads in a sensing result of the external world recognition device 1 (a result of recognizing the environment surrounding the subject vehicle).

In step S2, the autonomous driving control controller 4 reads in the behavior of the subject vehicle detected by the subject vehicle behavior detection device 3.

In step S3, the autonomous driving control controller 4 reads in the navigation information output from the autonomous driving information output device 17 of the navigation system 2 to the CAN communication line.

In step S4, the autonomous driving control controller 4 carries out a task regarding the switching of the running mode as interrupt processing. Details thereof will be described below.

In step S5, the autonomous driving control controller 4 determines whether the running mode is the autonomous driving mode. If the determination in step S5 is YES, the processing proceeds to step S6. If the determination in step S5 is NO, the processing proceeds to step S7.

In step S6, the autonomous driving control controller 4 carries out a control calculation for the autonomous driving. More specifically, the autonomous driving control controller 4 calculates the target steering angle and the target vehicle speed for causing the subject vehicle to automatically run based on the recommended route, and drives the steering device 8 according to the target steering angle and also drives the throttle device 9 and the brake device 10 according to the target vehicle speed.

In step S7, the autonomous driving control controller 4 diagnosis a failure and the like.

[Task regarding Switching of Running Mode]

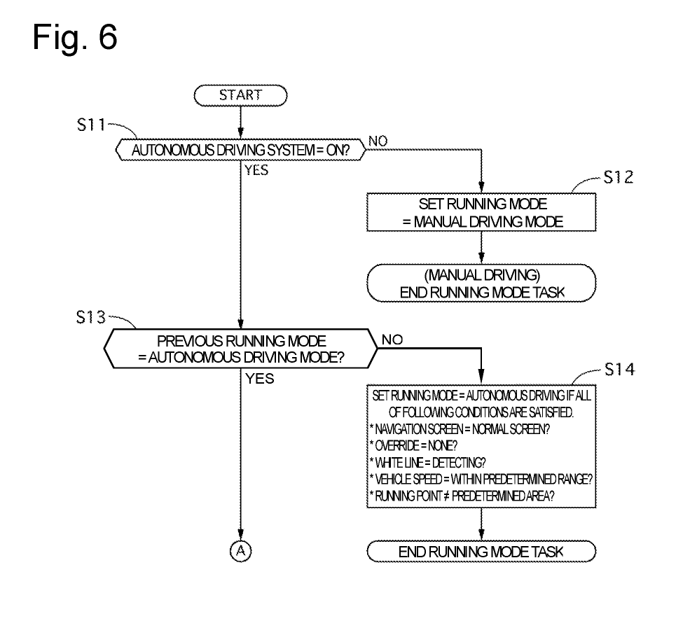

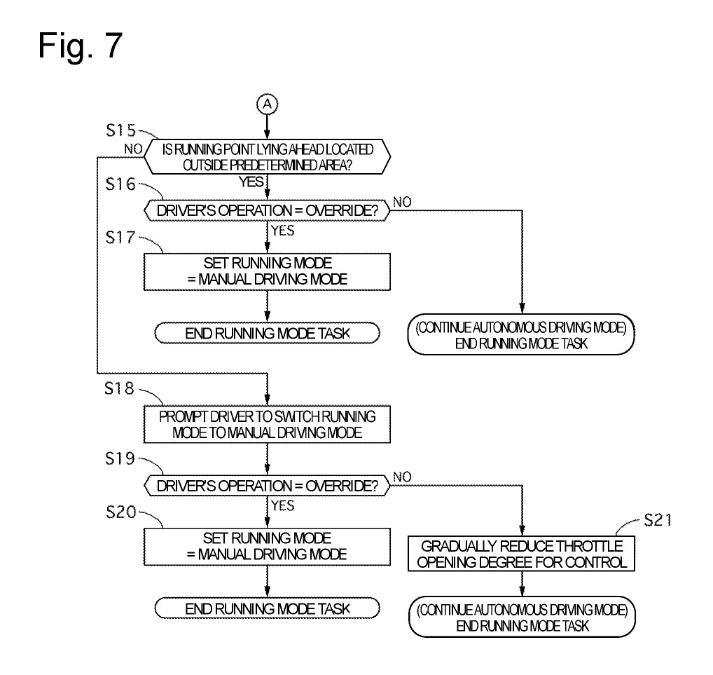

FIGS. 6 and 7 are flowcharts illustrating a flow of the task regarding the switching of the running mode according to the first embodiment. The autonomous driving control controller 4 includes a driving mode switching portion 4a, an autonomous driving difficulty determination portion 4b, and a driving mode switching prompt portion 4c as a configuration for carrying out the following task.

In step S11, the autonomous driving control controller 4 determines whether the autonomous driving system is turned on in the driving mode switching portion 4a, i.e., whether the driver selects the autonomous driving. If the determination in step S11 is YES, the processing proceeds to step S13. If the determination in step S11 is NO, the processing proceeds to step S13.

In step S12, the autonomous driving control controller 4 sets the running mode to the manual driving mode by the driving mode switching portion 4a, and then ends the task.

In step S13, the autonomous driving control controller 4 determines whether the running mode in the previous control cycle has been the autonomous driving mode by the driving mode switching portion 4a. If the determination in step S13 is YES, the processing proceeds to step S15. If the determination in step S13 is NO, the processing proceeds to step S14.

In step S14, the autonomous driving control controller 4 sets the running mode to the autonomous driving mode by the driving mode switching portion 4a if all of the following five conditions, which are the autonomous driving start conditions, are satisfied, and otherwise ends the task.
1. The display screen of the navigation system 2 is the normal screen (the map screen 22).
2. The driver does not override the autonomous driving.
3. The external world recognition device 1 is detecting a white line.
4. The vehicle speed falls within a predetermined range.
5. A current running point is located outside a predetermined area.

The display screen of the navigation system 2 and the running point are determined from the navigation information. Whether the driver overrides the autonomous driving or not is determined from a steering torque input by the driver, an accelerator operation amount, and a brake operation amount. Whether the external world recognition device 1 is detecting a white line is determined from the sensing result. Whether the vehicle speed falls within the predetermined range is determined from the behavior of the subject vehicle.

The “predetermined area” is the “area in which the autonomous driving is difficult”, and, for example, a non-orthogonal intersection, a junction of multiple roads, a curved road requiring a steering handle operation reaching or exceeding a predetermined steering angle, a road on which the speed limit is lower than a predetermined speed, a road on which a traffic sign or a road surface marking indicating a stop is set up, or an area in which the autonomous driving is prohibited. The area in which the autonomous driving is prohibited is a pre-registered area where a traffic accident frequently occurs, a private road, and the like. The area in which the autonomous driving is prohibited may be determined by referring to prior information dynamically registered by the autonomous driving control apparatus.

In step S15, the autonomous driving control controller 4 determines whether a running point lying ahead is located outside the predetermined area (the area in which the autonomous driving is difficult) by the autonomous driving difficulty determination portion 4b. If the determination in step S15 is YES, the processing proceeds to step S16. If the determination in step S15 is NO, the processing proceeds to step S18.

In step S16, the autonomous driving control controller 4 determines whether the driver overrides the autonomous driving by the driving mode switching portion 4a. If the determination in step S16 is YES, the processing proceeds to step S17. If the determination in step S16 is NO, the autonomous driving control controller 4 ends the task.

In step S17, the autonomous driving control controller 4 sets the running mode to the manual driving mode by the driving mode switching portion 4a, and then ends the task.

In step S18, the autonomous driving control controller 4 prompts the driver to switch the running mode from the autonomous mode to the manual mode, i.e., override the autonomous driving by the driving mode switching prompt portion 4c. At this time, the autonomous driving control controller 4 prompts the driver to switch the running mode to the manual driving mode with use of at least one method of the display by the HUD device 11 or the display device, the speech by the voice speech device 12, and the issuance of the warning sound by the warning device 13. The processing in this step is performed earlier than the display of, for example, the turn-by-turn screen 24 by the navigation system 2.

In step S19, the autonomous driving control controller 4 determines whether the driver overrides the autonomous driving by the driving mode switching portion 4a. If the determination in step S19 is YES, the processing proceeds to step S20. If the determination in step S19 is NO, the processing proceeds to step S21.

In step S20, the autonomous driving control controller 4 sets the running mode to the manual driving mode by the driving mode switching portion 4a, and then ends the task.

In step S21, the autonomous driving control controller 4 gradually reduces a throttle opening degree for controlling the speed with a goal thereof set to zero by the driving mode switching portion 4a, and then ends the task.

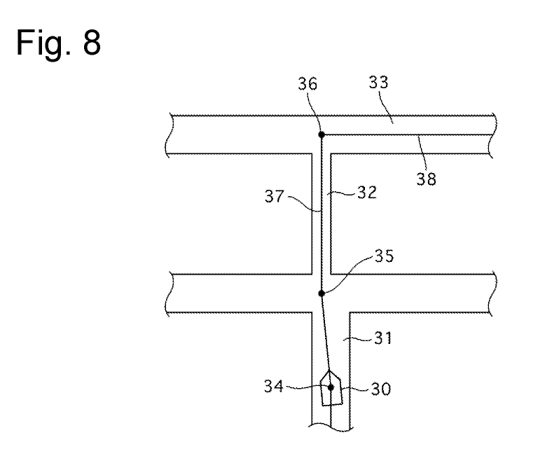

FIG. 8 illustrates an operation of the task regarding the switching of the running mode according to the first embodiment when the vehicle enters the area in which the autonomous driving is difficult during the autonomous driving. A subject vehicle 30 is running by the autonomous driving on a road 31 having a wide road width on which a speed limit is set, and the recommended route of the navigation system 2 is set onto the road 31, a road 32, and a road 33. Assume that the road 33 is also a road having a wide road width on which a speed limit is set similarly to the road 31, but the road 32 is a road having a narrow road width on which no speed limit is set.

In the task regarding the switching of the running mode according to the first embodiment, the autonomous driving control controller 4 determines that the road 32 corresponds to the area in which the autonomous driving is difficult based on information held by nodes 35 and 36 and a link 37 ahead of a running point 34 that is acquired at the current running point 34, in step S15, and prompts the driver to switch the running mode from the autonomous mode to the manual mode with use of the display, the voice, and/or the like in step S18. Due to this operation, the autonomous driving control apparatus can notify the driver in advance that the driver should switch the running mode from the autonomous mode to the manual mode because the vehicle will enter the road 32 on which the autonomous driving is difficult. Therefore, the driver can switch the running mode from the autonomous mode to the manual mode before entering the road 32, thereby running on the road 32 with the running mode switched to the manual driving mode. Then, the autonomous driving control apparatus prompts the driver to switch the running mode from the autonomous mode to the manual mode earlier than the display of the turn-by-turn screen 24 by the navigation system 2, and therefore can notify the driver further early that the vehicle will run on the road 32 in which the autonomous driving is difficult. At this time, if the driver does not override the autonomous driving, the autonomous driving control controller 4 gradually slows down the subject vehicle 30 in step S21. In other words, when being unable to continue the autonomous driving, the autonomous driving control apparatus stops the vehicle, and therefore can strongly prompt the driver to switch the running mode from the autonomous mode to the manual mode. At this time, because the control of the steering angle by the autonomous driving continues, the subject vehicle 30 runs along the traffic lane and therefore can be prevented from departing from the traffic lane.

As the subject vehicle 30 runs on the road 32 in the manual driving mode and reaches a portion connected to the road 32, the autonomous driving start conditions are satisfied in step S14 when the driver stops overriding the autonomous driving, so that the autonomous driving control apparatus switches the running mode from the manual mode to the autonomous mode.

Next, advantageous effects will be described.

The first embodiment brings about the following advantageous effects.

(1) The autonomous driving control apparatus includes the navigation controller 2f configured to detect the running point of the subject vehicle on the map, the driving mode switching portion 4a configured to, when the driver performs the driving operation during the autonomous driving mode of performing at least a part of the driving operation of the driver on behalf of the driver, switch the driving mode to the manual driving mode of causing the subject vehicle to run according to the driving operation, the autonomous driving difficulty determination portion 4b configured to, based on the information regarding the area located on the recommended route and lying ahead of the running point of the subject vehicle, determine whether the autonomous driving is difficult in the area, and the driving mode switching prompt portion 4c configured to prompt the driver to switch the driving mode to the manual driving mode if the autonomous driving is determined to be difficult in the area.

Therefore, when the vehicle enters the area in which the autonomous driving is difficult, the autonomous driving control apparatus can prompt the driver to switch the driving mode to the manual driving mode.

(2) The autonomous driving mode is the running mode of causing the subject vehicle to automatically run only on the portion on which the subject vehicle is determined to be able to run along a road based on the road state at the running point of the subject vehicle.

Therefore, the autonomous driving control apparatus can realize the cost reduction due to the reduction in the number of sensors and the simplification of the control compared to when employing the autonomous driving all through the recommended route.

(3) The driving mode switching prompt portion 4c prompts the driver to switch the driving mode to the manual driving mode when the entry of the subject vehicle into the area where the autonomous driving is determined to be difficult can be predicted.

Therefore, the autonomous driving control apparatus can notify the driver early that the vehicle will run in the area where the autonomous driving is difficult, thereby allowing the driver to switch the driving mode from the autonomous driving mode to the manual driving mode without delay.

(4) The driving mode switching prompt portion 4c prompts the driver to switch the driving mode to the manual driving mode before the guide indicating the change in the driving direction is presented to the driver by the navigation system 2.

Therefore, the autonomous driving control apparatus can notify the driver further early that the vehicle will run in the area where the autonomous driving is difficult, thereby allowing the driver to switch the driving mode from the autonomous driving mode to the manual driving mode well in advance.

(5) The information is information indicating at least one of the non-orthogonal intersection, the junction of multiple roads, the curved road requiring the steering handle operation reaching or exceeding the predetermined steering angle, the road on which the speed limit is lower than the predetermined speed, the road on which the traffic sign or the road surface marking indicating the stop is set up, and the pre-registered area in which the autonomous driving is prohibited.

Therefore, the autonomous driving control apparatus can accurately determine the area in which the autonomous driving is difficult.

### Second Embodiment

Next, a second embodiment will be described. The second embodiment is different from the first embodiment in terms of the task regarding the switching of the running mode.

[Task regarding Switching of Running Mode]

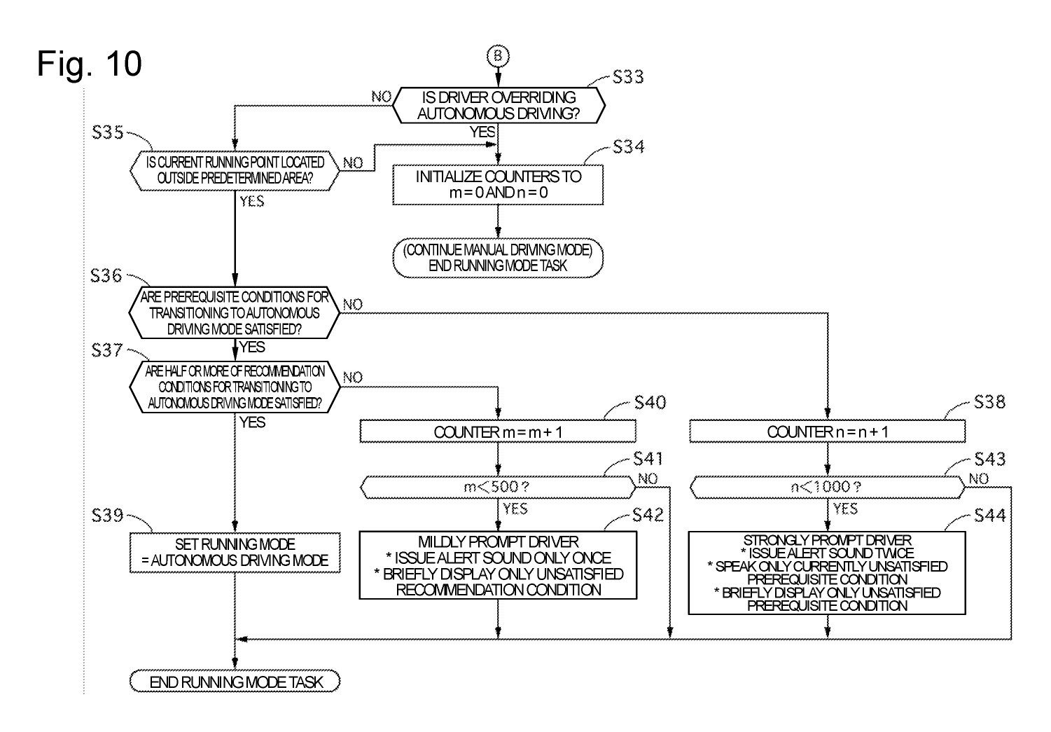

FIGS. 7, 9, and 10 are flowcharts illustrating a flow of the task regarding the switching of the running mode according to the second embodiment. This flow will be described, identifying steps, in which similar processing to the first embodiment is performed, by the same step numbers, and omitting descriptions thereof.

In step S31, the autonomous driving control controller 4 determines, by the driving mode switching portion 4a, whether the system is turned on for the first time after an ignition switch is turned on. If the determination in step S31 is YES, the processing proceeds to step S32. If the determination in step S31 is NO, the processing proceeds to step S33.

In step S32, the autonomous driving control controller 4 initializes a first counter m and a second counter n (clears them to zero) by the driving mode switching prompt portion 4c.

In step S33, the autonomous driving control controller 4 determines whether the driver is overriding the autonomous driving by the driving mode switching prompt portion 4c. If the determination in step S33 is YES, the processing proceeds to step S34. If the determination in step S33 is NO, the processing proceeds to step S35.

In step S34, the autonomous driving control controller 4 initializes the first counter m and the second counter n by the driving mode switching prompt portion 4c, and then ends the task.

In step S35, the autonomous driving control controller 4 determines whether the current running point is located outside the predetermined area (the area in which the autonomous driving is difficult) by the autonomous driving difficulty determination portion 4b. If the determination in step S35 is YES, the processing proceeds to step S36. If the determination in step S35 is NO, the processing proceeds to step S35.

In step S36, the autonomous driving control controller 4 determines whether prerequisite conditions for transitioning to the autonomous driving mode (a first condition) are satisfied by the driving mode switching portion 4a. If the determination in step S36 is YES, the processing proceeds to step S36. If the determination in step S36 is NO, the processing proceeds to step S37. The prerequisite conditions are the following three conditions based on the running environment, and the prerequisite conditions are determined to be satisfied if all of the three conditions are satisfied.
1. The road type is a main national road or an expressway.
2. The speed limit is a predetermined vehicle speed (for example, 40 km/h) or higher.
3. No traffic regulation due to bad weather or the like is imposed.

The road type and the speed limit are determined from the navigation information. The traffic regulation is determined from the traffic information of the beacon reception device 2a.

In step S37, the autonomous driving control controller 4 determines whether recommendation conditions for transitioning to the autonomous driving mode (a second condition) are satisfied (whether half or more of the recommendation conditions are satisfied) by the driving mode switching portion 4a. If the determination in step S37 is YES, the processing proceeds to step S38. If the determination in step S37 is NO, the processing proceeds to step S39. The recommendation conditions are the following three conditions based on the vehicle state, and the recommendation conditions are determined to be satisfied if two or more of the three conditions are satisfied.
1. An inter-vehicle distance between the subject vehicle and the vehicle running ahead is a predetermined distance or longer.
2. A position of the subject vehicle in the traffic lane is located around a center.
3. The running traffic lane is a traffic lane corresponding to a direction to which the vehicle will turn next (for example, a right turn lane if the vehicle will turn to the right next).

The inter-vehicle distance, the position in the traffic lane, and the running traffic lane are determined from the navigation information.

In step S38, the autonomous driving control controller 4 increments the second counter n (n=n+1) by the driving mode switching prompt portion 4c.

In step S39, the autonomous driving control controller 4 sets the running mode to the autonomous driving mode by the driving mode switching portion 4a, and then ends the task.

In step S40, the autonomous driving control controller 4 increments the first counter m (m=m+1) by the driving mode switching prompt portion 4c.

In step S41, the autonomous driving control controller 4 determines whether the first counter m is less than 500 by the driving mode switching prompt portion 4c. If the determination in step S41 is YES, the processing proceeds to S42. If the determination in step S41 is NO, the autonomous driving control controller 4 ends the task.

In step S42, the autonomous driving control controller 4 mildly prompts the driver to satisfy the conditions for transitioning to the autonomous driving mode by the driving mode switching prompt portion 4c, and then ends the task. More specifically, the autonomous driving control controller 4 issues an alert sound only once by the warning device 13, and briefly displays only an unsatisfied recommendation condition by the HUD device 11 or the display device 15.

In step S43, the autonomous driving control controller 4 determines whether the second counter n is less than 1000 by the driving mode switching prompt portion 4c. If the determination in step S43 is YES, the processing proceeds to S44. If the determination in step S43 is NO, the autonomous driving control controller 4 ends the task.

In step S44, the autonomous driving control controller 4 strongly prompts the driver to satisfy the conditions for transitioning to the autonomous driving mode by the driving mode switching prompt portion 4c, and then ends the task. More specifically, the autonomous driving control controller 4 issues an alert sound twice by the warning device 13, speaks only an unsatisfied prerequisite condition by the voice speech device 12, and briefly displays only the unsatisfied prerequisite condition by the HUD device 11 or the display device 15.

In the task regarding the switching of the running mode according to the second embodiment, the autonomous driving control apparatus prompts the driver to switch the running mode from the manual mode to the autonomous mode if determining that the current running point does not correspond to the area in which the autonomous driving is difficult, based on the information held by the node and the link that is acquired during the manual driving mode. This allows the autonomous driving to be restarted upon an exit from the area in which the autonomous driving is difficult. At this time, if not all of the prerequisite conditions for transitioning to the autonomous driving mode are satisfied, the autonomous driving control apparatus strongly prompts the driver to satisfy all of the prerequisite conditions since the current running point is determined not to correspond to the area in which the autonomous driving is difficult until the second counter n reaches 1000, i.e., 10 seconds have passed. This allows the driver to be aware of a reason why the running mode cannot be switched from the manual mode to the autonomous mode (the current environment is a running environment under which the running mode cannot be switched to the autonomous driving mode). On the other hand, if not half or more of the recommendation conditions for transitioning to the autonomous driving mode are satisfied, the autonomous driving control apparatus mildly prompts the driver to satisfy half or more of the recommendation conditions since the current running point is determined not to correspond to the area in which the autonomous driving is difficult until the first counter m reaches 500, i.e., 5 seconds have passed. This allows the driver to learn from an actual experience how the vehicle state (the inter-vehicle distance to the vehicle running ahead, the position in the traffic lane, and the position of the running traffic lane) should be changed to switch the running mode from the manual mode to the autonomous mode. In other words, the driver can grasp a tip for using the autonomous driving function for a long time. When not half or more of the recommendation conditions are satisfied, the autonomous driving control apparatus more mildly prompts the driver than when all of the prerequisite conditions are not satisfied, and therefore is prevented from bothering the driver or making the driver nervous.

Next, advantageous effects will be described.

The second embodiment brings about the following advantageous effects.

(6) The driving mode switching prompt portion 4c prompts the driver to switch the driving mode to the autonomous driving mode when the subject vehicle exits the area in which the autonomous driving is determined to be difficult. The driving mode switching portion 4a switches the driving mode to the autonomous driving mode when the driver stops the driving operation or turns on the autonomous driving selection button during the manual driving mode.

Therefore, the autonomous driving control apparatus allows the autonomous driving to be restarted upon the exit from the area in which the autonomous driving is difficult.

(7) The driving mode switching portion 4a switches the driving mode to the autonomous driving mode if both the prerequisite conditions based on the running environment of the subject vehicle and the recommendation conditions based on the running state of the subject vehicle are satisfied when the driver stops the driving operation or turns on the autonomous driving selection button during the manual driving mode. The driving mode switching prompt portion 4c prompts the driver to switch the driving mode to the autonomous driving mode by a different method between when only the prerequisite conditions are satisfied and when the prerequisite conditions are not satisfied.

Therefore, the autonomous driving control apparatus allows the driver to be aware of which is the reason why the driving mode cannot be switched to the autonomous driving mode, the running environment or the vehicle state.

### Third Embodiment

Next, a third embodiment will be described. The third embodiment is different from the first and second embodiments in terms of the task regarding the switching of the running mode.

[Task regarding Switching of Running Mode]

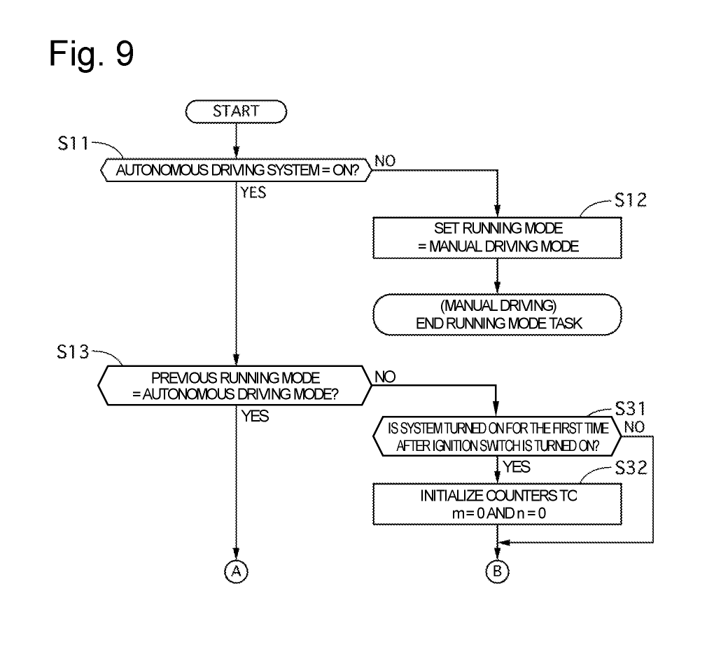

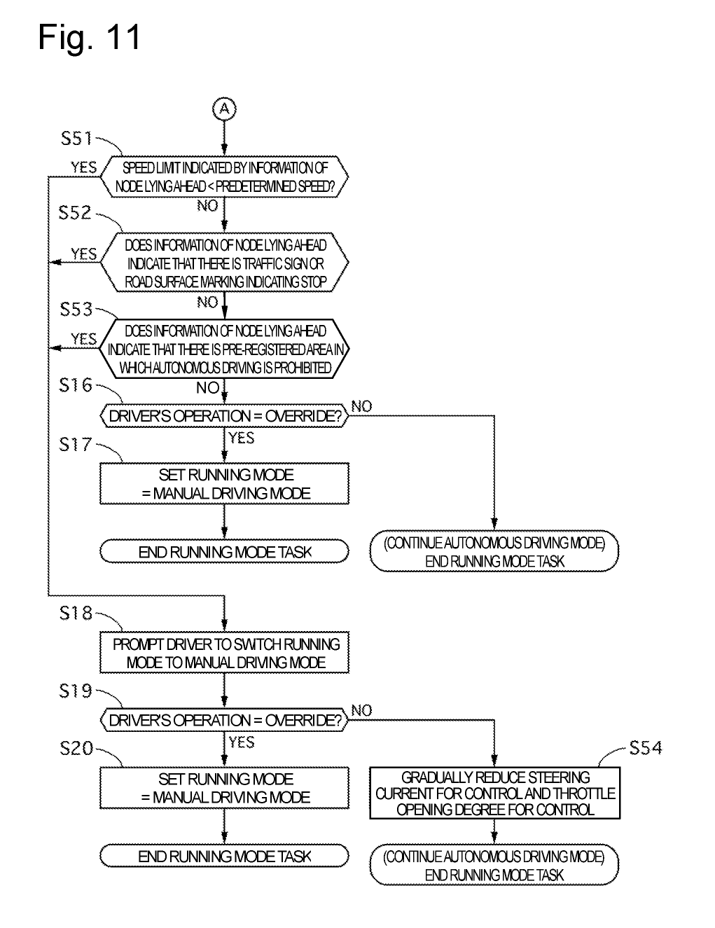

FIGS. 9, 10, and 11 are flowcharts illustrating a flow of the task regarding the switching of the running mode according to the third embodiment. This flow will be described, identifying steps, in which similar processing to the first or second embodiment is performed, by the same step numbers, and omitting descriptions thereof.

If the determination in step S13 is YES, the processing proceeds to step S51.

In step S51, the autonomous driving control controller 4 determines, by the autonomous driving difficulty determination portion 4b, whether the speed limit indicated by the information of a node lying ahead is lower than a predetermined speed. If the determination in step S51 is YES, the processing proceeds to step S18. If the determination in step S51 is NO, the processing proceeds to step S52.

In step S52, the autonomous driving control controller 4 determines, by the autonomous driving difficulty determination portion 4b, whether the information of the node lying ahead indicates that there is the traffic sign or the road surface marking indicating the stop. If the determination in step S52 is YES, the processing proceeds to step S18. If the determination in step S52 is NO, the processing proceeds to step S53. It is easy to stop the vehicle by the autonomous driving, but a start of movement of the vehicle accompanied by careful confirmation of safety after that is technically difficult, so that the running mode is set to the manual driving mode when the vehicle should be stopped.

In step S53, the autonomous driving control controller 4 determines, by the autonomous driving difficulty determination portion 4b, whether the information of the node lying ahead indicates that there is the pre-registered area in which the autonomous driving is prohibited. If the determination in step S53 is YES, the processing proceeds to step S18. If the determination in step S53 is NO, the processing proceeds to step S16.

In step S54, the autonomous driving control controller 4 gradually reduces a steering current for controlling the steering and the throttle opening degree for controlling the vehicle speed by the driving mode switching portion 4a, and then ends the task.

In the task regarding the switching of the running mode according to the third embodiment, the autonomous driving control apparatus gradually reduces a steering control amount and an acceleration control amount if the driver does not override the autonomous driving after the autonomous driving control apparatus prompts the driver to switch the running mode from the autonomous mode to the manual mode. As a result, the vehicle speed slows down, and, further, the steering motion also gradually reduces, by which the autonomous driving control apparatus can strongly prompt the driver to switch the running mode from the autonomous mode to the manual mode.

### Other Embodiments

Having described embodiments for implementing the present invention based on the exemplary embodiments thereof, the specific configuration of the present invention is not limited to the configurations indicated in the exemplary embodiments, and the present invention also includes even a design modification and the like thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects.

The “mild prompt” in step S42 may be any prompt as long as it prompts the driver more mildly than step S44. In other words, the “strong prompt” in step S44 may be any prompt as long as it prompts the driver more strongly than step S42. In the case where the prompt is presented with use of the display, visibility is increased (the display is enlarged, the display is highlighted, and/or the like) at the time of the strong prompt and reduced at the time of the mild prompt. In the case where the prompt is presented with use of the speech or the alert sound, a volume thereof is increased at the time of the strong prompt and reduced at the time of the mild prompt. Further, the prompt may be presented with use of the vibration of the steering wheel. In this case, the vibration is increased at the time of the strong prompt and reduced at the time of the mild prompt. The strong prompt may be realized by increasing the number of methods for transmitting the prompt, and the mild prompt may be realized by reducing the number of methods for transmitting the prompt.

The autonomous driving mode may be any function that performs at least a part of the driver's driving operation on behalf of the driver, and examples of the function employable therefor include the LKAS (Lane Keep Assist System) and the ACC (Adaptive Cruise Control). The LKAS assists the driver's steering wheel operation with the aim of preventing a departure from a traffic lane. The ACC causes the vehicle to automatically run at a constant speed while keeping a constant distance between vehicles. Basically, the LKAS and the ACC are used together with each other, but the vehicle may be configured to exert only one of them.

In the following description, technical ideas recognizable from the above-described embodiments will be described.

An autonomous driving control apparatus, according to one configuration thereof, includes a subject vehicle position detection portion configured to detect a running point of a subject vehicle on a map, a driving mode switching portion configured to, when a driver performs a driving operation during an autonomous driving mode of performing at least a part of a driving operation of the driver on behalf of the driver, switch a driving mode from the autonomous driving mode to a manual driving mode of causing the subject vehicle to run according to the driving operation, an autonomous driving difficulty determination portion configured to, based on information regarding an area lying ahead of the running point of the subject vehicle in a traveling direction, determine whether autonomous driving is difficult in the area, and a driving mode switching prompt portion configured to prompt the driver to switch the driving mode to the manual driving mode if the autonomous driving is determined to be difficult in the area.

According to more preferable configuration, in the above-described configuration, the autonomous driving mode is a running mode of causing the subject vehicle to automatically run only on a running route on which the subject vehicle is determined, based on a road state at the running point of the subject vehicle, to be able to run along a road.

According to further another preferable configuration, in any of the above-described configurations, the driving mode switching prompt portion prompts the driver to switch the driving mode to the manual driving mode only when entry of the subject vehicle into the area is predicted, if the autonomous driving is determined to be difficult in the area.

According to still another preferable configuration, in any of the above-described configurations, the driving mode switching portion gradually reduces an amount of controlling an actuator steering a steering target wheel and an amount of controlling an actuator adjusting a vehicle speed if the driver does not perform the driving operation after the driving mode switching prompt portion prompts the driver to switch the driving mode to the manual driving mode.

According to still another preferable configuration, in any of the above-described configurations, the driving mode switching portion reduces the vehicle speed if the driver does not perform the driving operation after the driving mode switching prompt portion prompts the driver to switch the driving mode to the manual driving mode.

According to still another preferable configuration, in any of the above-described configurations, a notification task for prompting the driver to switch the driving mode to the manual driving mode by the driving mode switching prompt portion is carried out earlier and/or in a more emphasized manner than a notification task for prompting the driver to switch the driving mode to the autonomous driving mode.

According to still another preferable configuration, in any of the above-described configurations, the driving mode switching prompt portion prompts the driver to switch the driving mode to the autonomous driving mode when the subject vehicle exits the area in which the autonomous driving is determined to be difficult. The driving mode switching portion switches the driving mode to the autonomous driving mode when the driver stops the driving operation or turns on an autonomous driving selection button during the manual driving mode.

According to still another preferable configuration, in any of the above-described configurations, the driving mode switching portion switches the driving mode to the autonomous driving mode if both a first condition based on a running environment of the subject vehicle and a second condition based on a running state of the subject vehicle are satisfied when the driver stops the driving operation or turns on the autonomous driving selection button during the manual driving mode. The driving mode switching prompt portion prompts the driver to switch the driving mode to the autonomous driving mode by a different method between when only the first condition is satisfied and when the first condition is not satisfied.

According to still another preferable configuration, in any of the above-described configurations, the driving mode switching prompt portion more strongly prompts the driver to switch the driving mode to the autonomous driving mode when the first condition is not satisfied than when only the first condition is satisfied.

According to still another preferable configuration, in any of the above-described configurations, the information is information indicating that the area includes at least one of a non-orthogonal intersection, a junction of multiple roads, a curved road requiring a steering handle operation reaching or exceeding a predetermined steering angle, a road on which a speed limit is lower than a predetermined speed, a road on which a traffic sign or a road surface marking indicating a stop is set up, and a pre-registered area in which the autonomous driving is prohibited.

Further, from another aspect, an autonomous driving control method includes detecting a running point of a subject vehicle on a map, switching a driving mode from an autonomous driving mode of performing at least a part of a driving operation of a driver on behalf of the driver to a manual driving mode of causing the subject vehicle to run according to the driving operation when the driver performs the driving operation during the autonomous driving mode, determining, based on information regarding an area lying ahead of the running point of the subject vehicle in a traveling direction, whether autonomous driving is difficult in the area, and prompting the driver to switch the driving mode to the manual driving mode if the autonomous driving is determined to be difficult.

In more preferable configuration, in the above-described configuration, the prompting the driver to switch the driving mode to the manual driving mode includes prompting the driver to switch the driving mode to the manual driving mode only when entry of the subject vehicle into the area is predicted if the autonomous driving is determined to be difficult in the area.

According to another preferable configuration, in any of the above-described configurations, a notification task for prompting the driver to switch the driving mode to the manual driving mode is carried out earlier and/or in a more emphasized manner than a notification task for prompting the driver to switch the driving mode to the autonomous driving mode.

According to further another preferable configuration, in any of the above-described configurations, the autonomous driving control method further includes prompting the driver to switch the driving mode to the autonomous driving mode when the subject vehicle exits the area in which the autonomous driving is determined to be difficult, and switching the driving mode to the autonomous driving mode when the driver stops the driving operation or turns on an autonomous driving selection button during the manual driving mode.

According to still another preferable configuration, in any of the above-described configurations, the autonomous driving control method further includes switching the driving mode to the autonomous driving mode if both a first condition based on a running environment of the subject vehicle and a second condition based on a running state of the subject vehicle are satisfied when the driver stops the driving operation or turns on the autonomous driving selection button during the manual driving mode, and prompting the driver to switch the driving mode to the autonomous driving mode by a different method between when only the first condition is satisfied and when the first condition is not satisfied.

According to still another preferable configuration, in any of the above-described configurations, the information is information indicating that the area includes at least one of a non-orthogonal intersection, a junction of multiple roads, a curved road requiring a steering handle operation reaching or exceeding a predetermined steering angle, a road on which a speed limit is lower than a predetermined speed, a road on which a traffic sign or a road surface marking indicating a stop is set up, and a pre-registered area in which the autonomous driving is prohibited.

The present application claims priority to Japanese Patent Application No. 2016-11783 filed on Jan. 25, 2016. The entire disclosure of Japanese Patent Application No. 2016-11783 filed on Jan. 25, 2016 including the specification, the claims, the drawings, and the abstract is incorporated herein by reference in its entirety.

### REFERENCE SIGN LIST

2f navigation controller (subject vehicle position detection portion)
4a driving mode switching portion
4b autonomous driving difficulty determination portion
4c driving mode switching prompt portion

1. An autonomous driving control apparatus comprising:
a subject vehicle position detection portion configured to detect a running point of a subject vehicle on a map;
a driving mode switching portion configured to, when a driver performs a driving operation during an autonomous driving mode of performing at least a part of a driving operation of the driver on behalf of the driver, switch a driving mode from the autonomous driving mode to a manual driving mode of causing the subject vehicle to run according to the driving operation;
an autonomous driving difficulty determination portion configured to, based on information regarding an area lying ahead of the running point of the subject vehicle in a traveling direction, determine whether autonomous driving is difficult in the area; and
a driving mode switching prompt portion configured to prompt the driver to switch the driving mode to the manual driving mode if the autonomous driving is determined to be difficult in the area.

2. The autonomous driving control apparatus according to claim 1, wherein the autonomous driving mode is a running mode of causing the subject vehicle to automatically run only on a running route on which the subject vehicle is determined, based on a road state at the running point of the subject vehicle, to be able to run along a road.

3. The autonomous driving control apparatus according to claim 1, wherein the driving mode switching prompt portion prompts the driver to switch the driving mode to the manual driving mode only when entry of the subject vehicle into the area is predicted, if the autonomous driving is determined to be difficult in the area.

4. The autonomous driving control apparatus according to claim 3, wherein a notification task for prompting the driver to switch the driving mode to the manual driving mode by the driving mode switching prompt portion is carried out earlier and/or in a more emphasized manner than a notification task for prompting the driver to switch the driving mode to the autonomous driving mode.

5. The autonomous driving control apparatus according to claim 4, wherein the driving mode switching portion gradually reduces an amount of controlling an actuator steering a steering target wheel and an amount of controlling an actuator adjusting a vehicle speed if the driver does not perform the driving operation after the driving mode switching prompt portion prompts the driver to switch the driving mode to the manual driving mode.

6. The autonomous driving control apparatus according to claim 4, wherein the driving mode switching portion reduces a vehicle speed if the driver does not perform the driving operation after the driving mode switching prompt portion prompts the driver to switch the driving mode to the manual driving mode.

7. The autonomous driving control apparatus according to claim 1, wherein the driving mode switching prompt portion prompts the driver to switch the driving mode to the autonomous driving mode when the subject vehicle exits the area in which the autonomous driving is determined to be difficult, and
wherein the driving mode switching portion switches the driving mode to the autonomous driving mode when the driver stops the driving operation or turns on an autonomous driving selection button during the manual driving mode.

8. The autonomous driving control apparatus according to claim 7, wherein the driving mode switching portion switches the driving mode to the autonomous driving mode if both a first condition based on a running environment of the subject vehicle and a second condition based on a running state of the subject vehicle are satisfied when the driver stops the driving operation or turns on the autonomous driving selection button during the manual driving mode, and
wherein the driving mode switching prompt portion prompts the driver to switch the driving mode to the autonomous driving mode by a different method between when only the first condition is satisfied and when the first condition is not satisfied.

9. The autonomous driving control apparatus according to claim 8, wherein the driving mode switching prompt portion more strongly prompts the driver to switch the driving mode to the autonomous driving mode when the first condition is not satisfied than when only the first condition is satisfied.

10. The autonomous driving control apparatus according to claim 1, wherein the information is information indicating that the area includes at least one of a non-orthogonal intersection, a junction of multiple roads, a curved road requiring a steering handle operation reaching or exceeding a predetermined steering angle, a road on which a speed limit is lower than a predetermined speed, a road on which a traffic sign or a road surface marking indicating a stop is set up, and a pre-registered area in which the autonomous driving is prohibited.

11. An autonomous driving control method comprising:
detecting a running point of a subject vehicle on a map;
switching a driving mode from an autonomous driving mode of performing at least a part of a driving operation of a driver on behalf of the driver to a manual driving mode of causing the subject vehicle to run according to the driving operation when the driver performs the driving operation during the autonomous driving mode;
determining, based on information regarding an area lying ahead of the running point of the subject vehicle in a traveling direction, whether autonomous driving is difficult in the area; and
prompting the driver to switch the driving mode to the manual driving mode if the autonomous driving is determined to be difficult.

12. The autonomous driving control method according to claim 11, wherein the prompting the driver to switch the driving mode to the manual driving mode includes prompting the driver to switch the driving mode to the manual driving mode only when entry of the subject vehicle into the area is predicted if the autonomous driving is determined to be difficult in the area.

13. The autonomous driving control method according to claim 12, wherein a notification task for prompting the driver to switch the driving mode to the manual driving mode is carried out earlier and/or in a more emphasized manner than a notification task for prompting the driver to switch the driving mode to the autonomous driving mode.

14. The autonomous driving control method according to claim 11, further comprising:
prompting the driver to switch the driving mode to the autonomous driving mode when the subject vehicle exits the area in which the autonomous driving is determined to be difficult; and
switching the driving mode to the autonomous driving mode when the driver stops the driving operation or turns on an autonomous driving selection button during the manual driving mode.

15. The autonomous driving control method according to claim 14, further comprising:
switching the driving mode to the autonomous driving mode if both a first condition based on a running environment of the subject vehicle and a second condition based on a running state of the subject vehicle are satisfied when the driver stops the driving operation or turns on the autonomous driving selection button during the manual driving mode; and
prompting the driver to switch the driving mode to the autonomous driving mode by a different method between when only the first condition is satisfied and when the first condition is not satisfied.

16. The autonomous driving control method according to claim 11, wherein the information is information indicating that the area includes at least one of a non-orthogonal intersection, a junction of multiple roads, a curved road requiring a steering handle operation reaching or exceeding a predetermined steering angle, a road on which a speed limit is lower than a predetermined speed, a road on which a traffic sign or a road surface marking indicating a stop is set up, and a pre-registered area in which the autonomous driving is prohibited.
